(19) United States
(12) Patent Application Publication
(10) Pub. No.: US 2025/0142653 A1
(43) Pub. Date: May 1, 2025

(54) OPERATING A USER EQUIPMENT CAPABLE OF CONNECTING TO MULTIPLE PUBLIC LAND MOBILE NETWORKS

(71) Applicant: Telefonaktiebolaget LM Ericsson (publ), Stockholm (SE)

(72) Inventors: Lian ARAUJO, Solna (SE); Mattias BERGSTRÖM, Singapore (SG); Antonino ORSINO, Kirkkonummi (FI)

(21) Appl. No.: 18/834,557

(22) PCT Filed: Jan. 31, 2023
(86) PCT No.: PCT/EP2023/052327

§ 371 Date: Jul. 30, 2024

Related U.S. Application Data
(60) Provisional application No. 63/304,925, filed on Jan. 31, 2022.

(51) Int. Cl. H04W 76/14; H04W 84/04; H04W 88/06

(52) U.S. Cl. CPC H04W 76/14; H04W 84/042; H04W 88/06

(57) ABSTRACT

There is provided a method of operating a first user equipment (UE) that is capable of connecting to multiple public land mobile networks (PLMNs). The method includes establishing a connection to a first PLMN, establishing a sidelink connection to a second UE, generating a gap preference for configuring communication gaps with the first PLMN, and transmitting the gap preference to the first PLMN. The gap preference is at least partly based on the sidelink connection to the second UE.

### TECHNICAL FIELD

The disclosure relates to a user equipment that is capable of connecting to multiple public land mobile networks and methods of operating the user equipment.

### BACKGROUND

The third generation partnership project (3GPP) has specified the long term evolution (LTE) device-to-device (D2D) technology, also known as Proximity Services (ProSe) in the Release 12 and 13 of LTE. Later in Release 14 and Release 15, LTE vehicle to everything (V2X) related enhancements targeting the specific characteristics of vehicular communications were specified. 3GPP has started a new work item (WI) within the scope of Release 16 to develop a new radio (NR) version of V2X communications. The NR V2X mainly targets advanced V2X services, which can be categorized into four use case groups: vehicle platooning, extended sensors, advanced driving and remote driving. It is currently anticipated that advanced V2X services will require an enhanced NR system and a new NR sidelink framework to meet the stringent requirements in terms of latency and reliability. It is also expected that the NR V2X system will also have higher system capacity and better coverage and will allow for an easy extension to support the future development of advanced V2X services and other services.

Given the services targeted by NR V2X, it is commonly recognized that groupcast/multicast and unicast transmissions are desired. In such transmissions, the intended receiver of a message consists of only a subset of the vehicles in proximity to the transmitter (groupcast/multicast) or of a single vehicle (unicast). For example, in the platooning service there are certain messages that are only of interest to the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between user equipments (UEs) and the network (NW), including support for standalone, network-less operation.

Each sidelink communication is identified by a pair of source and destination layer 2 (L2) identifiers (IDs). The source L2 ID is allocated by the UE itself. For unicast, the destination L2 ID is the source L2 ID of a peer UE and is allocated by the peer UE. For groupcast/broadcast, the destination L2 ID is mapped from the service/application.

In 3GPP Release 17, national security and public safety (NSPS) is considered to be an important use case that can benefit from the existing NR sidelink features in Release 16. 3GPP has decided to specify enhancements related to the NSPS use case taking NR Release 16 sidelink as a baseline. In some scenarios where the infrastructure may be damaged or not available, such as indoor firefighting, forest firefighting, earthquake rescue, sea rescue, etc., NSPS services need to operate with partial NW coverage or even without NW coverage. Therefore, coverage extension is an important feature for NSPS. In Release 17, a new work item description (WID) for NR sidelink relay has been launched, which aims to further explore NW coverage extension using a UE to NW relay, including both a layer 2 (L2) and layer 3 (L3) UE to NW relay. The UE to NW relay can itself be a UE and can thus be referred to as a UE to NW relay UE or, more simply, a relay UE.

The L2 UE to NW relay UE arrangement provides the functionality to support connectivity to a fifth generation system (5GS) NW for remote UEs. A protocol stack for an L2 UE to NW relay UE is shown in FIG. 1 and FIG. 2 for the user plane (UP) and the control plane (CP) respectively. As shown in FIG. 1, the two endpoints of a packet data convergence protocol (PDCP) link are the remote UE and the gNodeB (gNB), which means the remote UE has its own context in the radio access network (RAN) and the core NW. That is, the remote UE has its own radio bearer, radio resource control (RRC) connection and protocol data unit (PDU) session. The relay function is performed below the PDCP at the adaptation layer. The remote UE's traffic (both control plane and user plane traffic) is transparently transferred between the remote UE and the gNB over the L2 UE to NW relay UE without any modifications.

The adaptation layer between the L2 UE to NW relay UE and the gNB is able to differentiate between Uu bearers of a particular remote UE. Different remote UEs and different Uu bearers of the remote UE are indicated by additional information (e.g. UE IDs and bearer IDs) included in adaptation layer header which is added to PDCP PDU. The adaptation layer can be considered as part of PDCP sublayer or a separate new layer between PDCP sublayer and radio link control (RLC) sublayer.

When both the remote UE and the L2 UE to NW relay UE are in an RRC idle/inactive mode and there is incoming downlink (DL) traffic for the remote UE, the NW will first page the remote UE. The L2 UE to NW relay UE monitors the paging and informs the remote UE that there is DL traffic for it. Then, both the remote UE and the L2 UE to NW relay UE establish/resume the RRC connection to the gNB and the remote UE's traffic is transparently transferred between the remote UE and gNB over the L2 UE to NW relay UE.

The L3 UE to NW relay UE relays unicast traffic (UL and DL) between the remote UE and the network. It provides generic functionality that can relay any internet protocol (IP), Ethernet or unstructured traffic. The protocol stack for an L3 UE to NW relay UE is shown in FIG. 3, where relaying is performed in the PDU layer. The remote UE is invisible to the core NW. That is, the remote UE does not have its own context and PDU session in the core NW, and its traffic is forwarded in the relay UE's PDU session. For IP PDU Session Type and IP traffic over the PC5 reference point, the L3 UE to NW relay UE allocates an IP version 6 (IPv6) prefix or an IP version 4 (IPv4) address for the remote UE.

In case the L3 UE to NW relay UE is in an RRC idle/inactive mode and there is incoming DL traffic for the remote UE, the NW will first page the L3 UE to NW relay UE, which triggers the L3 UE to NW relay UE to establish/resume the RRC connection. Then, the NW sends the remote UE's traffic to the L3 UE to NW relay UE, which further forwards it to the remote UE.

3GPP is currently studying in Release 17 how to best support UEs that can manage two or more simultaneous subscriptions using multiple universal subscriber identity modules (USIMs), referred to as a multi-USIM or MUSIM. A MUSIM-capable UE is capable of having two or more subscription credentials and basically to “act” as two UEs within one device/hardware entity. Even though mobile terminals with such properties exist, most operations for such UEs are not optimized, as there is no specific standardized support for MUSIM, which would make it easier for UEs to manage two or more subscriptions simultaneously.

### SUMMARY

It is an object of the disclosure to obviate or eliminate at least some of the above-described disadvantages associated with existing techniques.

Therefore, according to an aspect of the disclosure, there is provided a first method of operating a first user equipment (UE) that is capable of connecting to multiple public land mobile networks (PLMNs). The method comprises establishing a connection to a first PLMN, establishing a sidelink connection to a second UE, generating a gap preference for configuring communication gaps with the first PLMN, and transmitting the gap preference to the first PLMN. The gap preference is at least partly based on the sidelink connection to the second UE,

According to another aspect of the disclosure, there is provided a second method of operating a first UE that is capable of connecting to multiple PLMNs. The method comprises establishing a connection to a first PLMN, establishing a sidelink connection to a second UE, receiving a paging message from a second PLMN, and sending a message to the second UE indicating that the sidelink connection will be interrupted.

According to another aspect of the disclosure, there is provided a third method of operating a first UE that is capable of connecting to multiple PLMNs. The method comprises establishing a connection to a first PLMN and, after establishing the connection to the first PLMN, ceasing or avoiding to establish a sidelink connection for UEs in a second PLMN.

According to another aspect of the disclosure, there is provided a first UE comprising a processor and a memory. The memory comprises computer-readable instructions that, when executed by the processor, cause the first UE to perform operations according to the first method, the second method, or the third method.

According to another aspect of the disclosure, there is provided a computer program product comprising a non-transitory computer readable storage medium comprising computer readable instructions that, when executed by a processor of a first UE, cause the first UE to perform operations according to the first method, the second method, or the third method.

### BRIEF DESCRIPTION OF THE DRAWINGS

For a better understanding of the technique, and to show how it may be put into effect, reference will now be made, by way of example, to the accompanying drawings, in which:

FIG. 1 is a protocol stack for an L2 UE to NW relay UE for the UP;

FIG. 2 is a protocol stack for an L2 UE to NW relay UE for the CP;

FIG. 3 is a protocol stack for an L3 UE to NW relay UE;

FIGS. 4-6 are block diagrams illustrating methods according to some embodiments;

FIG. 7 is a system according to an embodiment;

FIGS. 8A, 8B and 9-11 are signalling diagrams illustrating an exchange of signals in a system according to some embodiments;

FIGS. 12-16 are block diagrams illustrating methods according to some embodiments;

FIG. 17 is an example of a communication system in accordance with some embodiments;

FIG. 18 is a UE in accordance with some embodiments;

FIG. 19 is a network node in accordance with some embodiments;

FIG. 20 is a block diagram of a host in accordance with some embodiments;

FIG. 21 is a block diagram illustrating a virtualization environment in accordance with some embodiments; and

FIG. 22 is a communication diagram of a host in accordance with some embodiments.

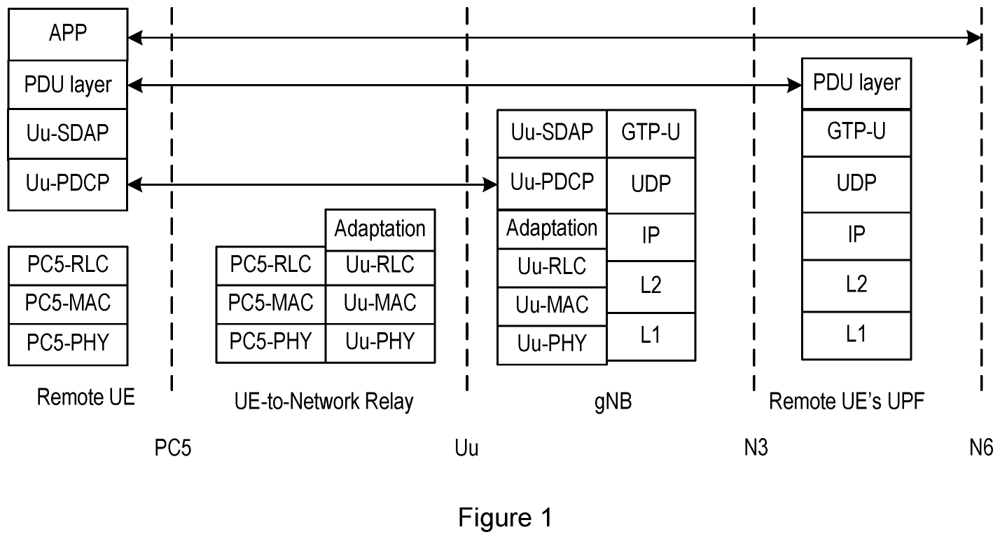

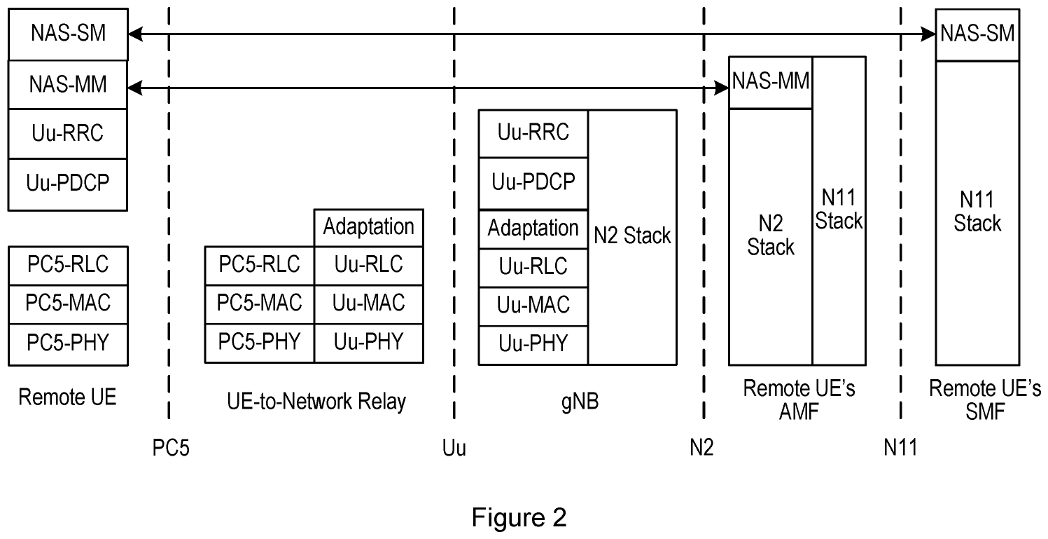

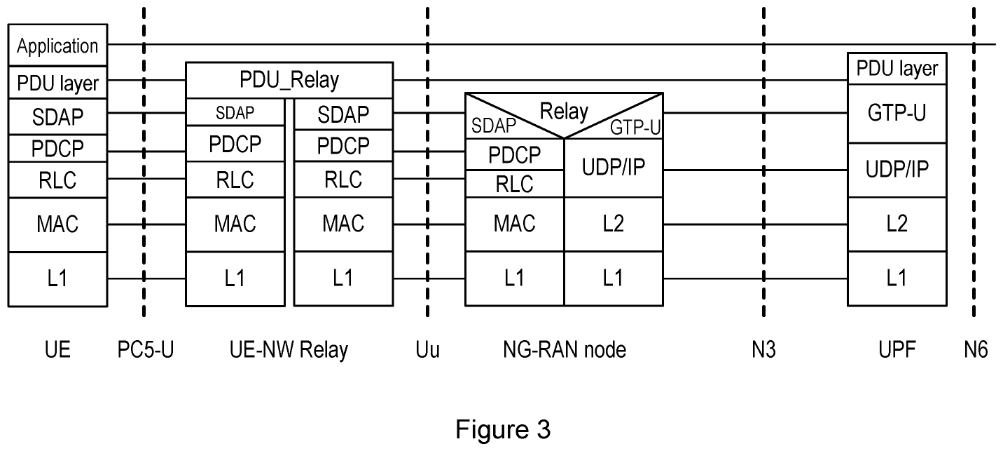

### DESCRIPTION

Several challenges exist with respect to standardization of MUSIM. For example, a UE may need to be provided support to more easily switch between states related to utilization of one subscription (e.g., a first USIM (“USIM1”), connecting to a first PLMN (“PLMN A”)) and states related to utilization or communication using another subscription (e.g., a second USIM (“USIM2”), connecting to a second PLMN (“PLMN B”)) as such states may be dependent on the connection status to the PLMN (e.g., an RRC connected (“RRC_CONNECTED”) status). Such switching may be straightforward, or maybe not even necessary, if the UE has the capability of communicating simultaneously towards two networks, using USIM1 and USIM2 simultaneously. For this to work, there may be a need for the UE to have dual receiver and transmitter chains. It may also be necessary that frequencies that are used towards both networks do not cause interference to each other and that radio separation is good enough to avoid intermodulation (IM) effects in the device. Yet another aspect that can be addressed by standardization is to provide signaling that allows a UE that cannot simultaneously communicate with two or more networks to at least signal a network that it is leaving, or becoming unreachable for that network.

There currently exist certain challenge(s) with MUSIM, which are particularly apparent in the context of sidelink relay scenarios.

One challenge is that when a first UE (e.g. a relay UE) is configured with periodic gaps for MUSIM purposes, if the first UE has an active sidelink connection with a second UE (e.g. a remote UE), the sidelink connection can be interrupted during the periodic gaps configured for the first UE. Thus, any data transmission ongoing from the network to the second (e.g. remote) UE via the first (e.g. relay) UE may be interrupted since the first (e.g. relay) UE cannot receive such data from the network during the configured gaps.

The first UE may also request aperiodic gaps for MUSIM purposes, which may further interrupt the sidelink connection with the second UE.

Another problem is that the first UE may need to read paging for the second UE in another network. In such a case, if the first UE is configured with gaps for MUSIM purposes, such gaps may be insufficient for reading paging for the second UE.

Another challenge is that a UE that supports MUSIM operations may be paged by two network operators. However, the UE can be in a connected state (e.g., RRC_CONNECTED) to only one network at a time. When a MUSIM UE is in an RRC CONNECTED mode in one network, the UE can be paged by another network. The paging message may include a paging cause indication that indicates a reason why the UE has been paged (e.g., voice call, emergency service, video, etc.).

In a sidelink relay scenario, a UE that supports MUSIM operations may act as a relay UE that enables a remote UE to be connected to the network. In that case, if the relay UE is paged by another network operator and decides to leave the current network, the switch to the new network will impact the remote UE connection. This may be undesirable for the remote UE, as the remote UE may be transmitting high priority traffic (such as emergency or URLCC traffic) on the original network, and it may be undesirable to interrupt the connection, or the new network may be otherwise unable to support the services needed by the remote UE.

Moreover, the change of networks may cause a sudden connectivity interruption for the remote UE. Even if the remote UE is connected to the new network, the remote UE may experience a higher signaling overhead, since the remote UE needs to perform cell discovery and cell and relay (re)selection, and then establish a new connection with the new network.

Also, if the relay UE changes networks without informing the remote UE, it may take a significant amount of time for the remote UE to determine that the relay UE has changed networks because there is currently no indication supported over the PC5 interface for this scenario. This is not preferrable in case of low latency, high reliability use cases, such as public safety or ultra reliable low latency communication (URLLC).

Another challenge is that there is currently no standardized solution for a relay UE, which is associated with a first PLMN, to avoid having remote UEs of a second PLMN connect to it.

Certain aspects of the disclosure and their embodiments may provide solutions to these or other challenges.

The embodiments will be described herein from the perspective of a first user equipment (UE), a second UE, and a network (NW). The first UE and the second UE can communicate with each other via a sidelink (SL) or SL connection. In some embodiments, the first UE can be a remote (RM) UE and the second UE can be a relay (RL) UE. In other embodiments, the second UE can be an RM UE and the first UE can be an RL UE. Any other UE(s) referred to herein may also be a RM UE or a RL UE according to some embodiments.

An RM UE is a UE that is remote from the NW. As such, the RM UE is unable to communicate directly with the NW (e.g. any node of the NW, i.e. any NW node). A relay service is a service that allows an RM UE to communicate with the NW via an RL UE. An RL UE is a UE that can relay traffic from the RM UE to the NW and/or from the NW to the RM UE. In this way, a UE-to-NW relay service can be provided. Thus, an RL UE can also be referred to as a UE-to-NW relay UE.

Herein, a UE may be described as being in a particular state (or mode), such as a radio resource control (RRC) state. Examples of a state can include an idle state, a connected state, and an inactive state. An idle state can be where a UE is not connected to the NW (e.g. any NW nodes). A connected state can be where a UE has both connection to a RAN node (e.g. gNodeB) and connection to a core NW node (e.g. an access and mobility management function (AMF) node) via the RAN node. An inactive state can be where a UE is not connected to a RAN node (e.g. gNodeB), but the connection between the RAN node and the core NW node (e.g. AMF) is kept.

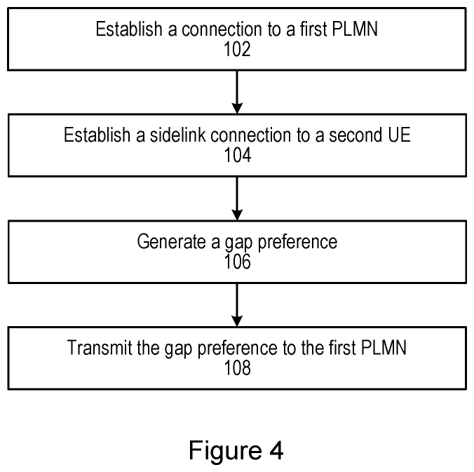

FIG. 4 illustrates a method of operating a first UE that is capable of connecting to multiple PLMNs, according to an embodiment. At block 102, a connection to a first PLMN is established. At block 104, a sidelink connection to a second UE is established. At block 106, a gap preference is generated for configuring communication gaps with the first PLMN. The gap preference is at least partly based on the sidelink connection to the second UE. At block 108, the gap preference is transmitted to the first PLMN.

In some embodiments, the gap preference may comprise a larger gap length of more frequent periodicity than a gap preference of the first UE that is not based on the sidelink connection. In some embodiments, the gap preference may be transmitted to the first PLMN in a UE assistance information message or a sidelink UE information message. In some embodiments, the gap preference may comprise an offset to be applied in addition to a first gap preference of the first UE that is generated without reference to the sidelink connection.

Although not illustrated in FIG. 4, in some embodiments, the method may further comprise transmitting the gap preference to the second UE. In some embodiments, the gap preference may be transmitted to the second in a UE assistance information message.

Although not illustrated in FIG. 4, in some embodiments, the method may further comprise requesting a second UE gap preference from the second UE and receiving the second UE gap preference from the second UE. The gap preference may be based on the second UE gap preference received from the second UE.

Although not illustrated in FIG. 4, in some embodiments, the method may further comprise receiving a gap configuration from the first PLMN and transmitting the gap configuration to the second UE. In some embodiments, the gap preference may be transmitted to the first PLMN using radio resource control (RRC) signalling. In other embodiments, the gap preference may be transmitted to the first PLMN using medium access control (MAC) signalling. In other embodiments, the gap preference may be transmitted to the first PLMN as part of a random access (RA) procedure.

In some embodiments, the second UE may be a remote UE and establishing the sidelink connection to the second UE may comprise establishing the sidelink connection as a relay UE to the second UE. In some embodiments, the first UE may be capable of connecting to multiple PLMNs using multiple universal subscriber identity modules (MUSIMs) and the gap preference may be a MUSIM gap preference for configuring communication gaps with the first PLMN to support MUSIM operations.

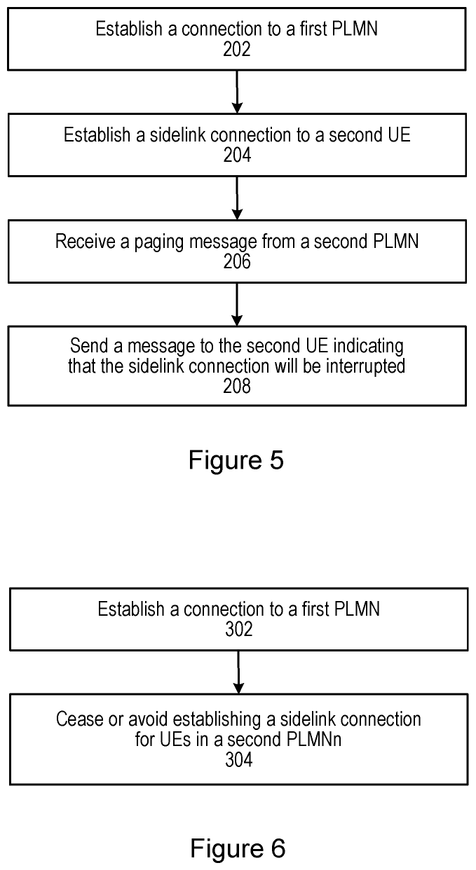

FIG. 5 illustrates a method of operating a first UE that is capable of connecting to multiple PLMNs, according to an embodiment. At block 202, a connection to a first PLMN is established. At block 204, a sidelink connection to a second UE is established. At block 206, a paging message is received from a second PLMN. At block 208, a message is sent to the second UE indicating that the sidelink connection will be interrupted.

In some embodiments, the message may indicate that the first UE intends to leave the first PLMN. In some embodiments, the message may indicate that the first UE received the paging message from the second PLMN. In some embodiments, the message may indicate a cause for leaving the first PLMN. In some embodiments, the message may request traffic, quality of service and/or service information from the second UE. Although not illustrated in FIG. 5, in some embodiments, the method may further comprise receiving the traffic, quality of service and/or service information from the second UE. Although not illustrated in FIG. 5, in some embodiments, the method may further comprise determining whether to leave the first PLMN based on the traffic, quality of service and/or service information received from the second UE. Although not illustrated in FIG. 5, in some embodiments, the method may further comprise after receiving the traffic, quality of service and/or service information from the second UE, transmitting an indication to the second UE that the first UE intends to leave the first PLMN.

Although not illustrated in FIG. 5, in some embodiments, the method may further comprise receiving an accept/reject message from the second UE indicating whether the second UE accepts or rejects moving to the second PLMN. In some embodiments, the accept/reject message may comprise a reject message indicating that the second UE rejects moving to the second PLMN. In some of these embodiments, the method may further comprise, in response to the reject message, determining not to leave the first PLMN and transmitting a response message to the second UE indicating that the first UE will stay in the first PLMN. In some embodiments, the accept/reject message may comprise an accept message indicating that the second UE accepts moving to the second PLMN. In these embodiments, the method may further comprise, in response to the accept message, transmitting a request to the second PLMN requesting permission to host the second UE in the second PLMN.

Although not illustrated in FIG. 5, in some embodiments, the method may further comprise receiving an acknowledgement from the second PLMN granting the permission to host the remote UE in the second PLMN. The acknowledgement may include a sidelink configuration for hosting the second UE in the second PLMN. In some of these embodiments, the method may further comprise transmitting the sidelink configuration to the second UE.

In some embodiments, wherein the second UE may be a remote UE and establishing the sidelink connection to the second UE may comprise establishing the sidelink connection as a relay UE to the second UE. In some embodiments, the first UE may be capable of connecting to multiple PLMNs using MUSIMs.

FIG. 6 illustrates a method of operating a first UE that is capable of connecting to multiple PLMNs, according to an embodiment. At block 302, a connection to a first PLMN is established. At block 304, after establishing the connection to the first PLMN, establishment of a sidelink connection for UEs in a second PLMN is ceased or avoided.

In some embodiments, ceasing to establish a sidelink connection for UEs in the second PLMN may comprise disabling a sidelink discovery procedure in the second PLMN. In some embodiments, ceasing or avoiding to establish a sidelink connection for UEs in the second PLMN may comprise stopping an ongoing sidelink connection with a second UE in the second PLMN. In some embodiments, ceasing or avoiding to establish a sidelink connection for UEs in the second PLMN may comprise indicating in a sidelink discovery message that the first UE is not willing to establish a sidelink connection for UEs in the second PLMN.

Although not illustrated in FIG. 6, in some embodiments, the method may further comprise indicating, in the sidelink discovery message, a time period in which the first UE is not willing to establish a sidelink connection for UEs in the second PLMN.

In some embodiments, the connection to the first PLMN may comprise an inactive or idle connection and a connection to the second PLMN may comprise an inactive or idle connection. In some of these embodiments, the method may further comprise enabling a sidelink discovery procedure in the first PLMN and the second PLMN, accepting a first sidelink connection from a second UE in the first PLMN, and rejecting a second sidelink connection from a third UE in the second PLMN.

Although not illustrated in FIG. 6, in some embodiments, the method may further comprise determining whether to accept sidelink connections in the first PLMN or the second PLMN based on a quality of a sidelink channel of the first UE in the first PLMN compared to a quality of a sidelink channel of a second UE in the second PLMN.

In some embodiments, the connection to the first PLMN may comprise an inactive or idle connection and a connection to the second PLMN may comprise an inactive or idle connection. In some of these embodiments, the method may further comprise transmitting sidelink discovery messages only in the first PLMN.

In some embodiments, ceasing or avoiding to establish a sidelink connection for UEs in a second PLMN may comprise ceasing or avoiding to act as a relay UE for UEs in the second PLMN. In some embodiments, the first UE may be capable of connecting to multiple PLMNs using MUSIMs.

There is also provided a first UE comprising a processor and a memory. The memory comprises computer-readable instructions that, when executed by the processor, cause the first UE to perform operations according to the method described with reference to FIG. 4, FIG. 5, and/or FIG. 6.

There is also provided a computer program product comprising a non-transitory computer readable storage medium. The non-transitory computer readable storage medium comprises computer readable instructions that, when executed by a processor of a first UE, cause the first UE to perform operations according to the method described with reference to FIG. 4, FIG. 5, and/or FIG. 6.

Herein, a communication gap can refer to a gap that allows a first UE to perform a predefined operation (e.g. a sidelink operation, a monitoring paging operation, a measurement operation (such as a measurement on another frequency or to another network) and/or any other operation). This gap can be a period of time in which the UE is to stop any transmission and reception, and start performing the predefined operation. A gap preference can refer to a preference for/on the communication gap. For example, the communication gap can refer to a gap that allows a first UE to perform a MUSIM operation and the gap preference can be a preference for/on such a communication gap. A MUSIM operation can be an activity performed with more than one USIM (e.g. a sidelink operation for multiple USIMs, a monitoring paging operation for multiple USIMs, and/or any other operation for multiple USIMs). Examples of a gap preference include, but are not limited to, a length or duration of the gap (i.e. a gap length or gap duration), a repetition value for the gap, and/or any other gap preference.

The first UE may provide an indication of the gap preference according to some embodiments. The gap preference can, for example, be indicative of which gap is suitable for the network to configure for the first UE to perform the predefined (e.g. MUSIM) operation. Although the first UE can indicate a gap preference, it may be that the network makes the final configuration decision according to some embodiments.

As mentioned earlier, the gap preference is at least partly based on the sidelink connection to the second UE. That is, the gap preference can be influenced by the operation of the first UE with the sidelink connection to the second UE. For example, the decision of the first UE on which gap to indicate to the network (e.g. length, repetition values, etc.) can be influenced by the operation of the first UE with the sidelink connection to the second UE (e.g. larger gap length due to an ongoing sidelink operation).

Some embodiments described herein enable a first UE, which is capable of MUSIM operations, to not only take into account its own preferences, but also preferences of a second UE (such as a remote UE for which the first UE is serving as a relay UE) when sending gap preferences (e.g. for MUSIM coordination) to the network.

This can be achieved by applying one or more of the following embodiments.

In a first embodiment, the first (e.g. relay) UE, when configured to provide gap preferences for MUSIM purposes, may send gap preferences to the network with values that also consider requirements related to a second (e.g. remote) UE. Such gap preferences may include larger gap lengths, more frequent periodicity, etc. The gap preferences indicated by the first UE may also take into account sidelink requirements.

In some cases, the first UE may explicitly indicate gap preferences that are related to the second UE. For example, the first UE may indicate to the network a preference for additional gap patterns that could be used by the second UE. The first UE may indicate to the network which UE the additional gap patterns are requested for (in this case, the second UE). The network can then have visibility of which preferences are related to the first UE and which are related to the second UE.

In a second embodiment, the first UE, when configured to provide gap preferences for MUSIM purposes, may send gap preferences to the second UE, so that the second UE can know the periods of unavailability of the first UE.

In some cases, the first UE may indicate the gaps that have actually been configured by the network, as the network may not necessarily configure the gaps as requested or indicated by the first UE.

In a third embodiment, the second UE may be configured to provide gap preferences to the first UE. The first UE can then combine its own gap preferences with the ones from the second UE.

In some cases, the second UE can provide its gap preferences directly to the network via an encapsulated message through the first UE. The network can then have visibility of which preferences are related to the first UE and which are related to the second UE. In this case, the gap preference of the first and second UE may be sent independently to the network.

Some embodiments described herein enable a first (e.g. relay) UE, which is capable of MUSIM operations, to take into account not only its own traffic, but also the traffic of a second UE (such as a remote UE for which it is acting as a relay UE) in case the second (e.g. relay) UE is paged by another network. Some embodiments further provide that the second (e.g. remote) UE, which is capable of MUSIM operations, may not only take into account its own traffic, but also the traffic of the first (e.g. relay) UE in case the first (e.g. relay) UE is paged by another network.

In particular, some embodiments provide that a first (e.g. relay) UE, when receiving a paging indication from another network, sends a message to the second (e.g. remote) UE to indicate that the first (e.g. relay) UE intends to leave the network. The message may further indicate the reason why the first (e.g. relay) UE intends to leave, such as because the first (e.g. relay) UE has been paged by another network.

In some embodiments, the message may inform the second (e.g. remote) UE that the first (e.g. relay) UE has been paged by a different network operator and may include the cause of the paging. In that case, the second (e.g. remote) UE may reply back to the first (e.g. relay) UE by accepting or rejecting the first (e.g. relay) UE's indication to leave the current network. If the second (e.g. remote) UE rejects the message but the first (e.g. relay) UE leaves the network anyway, the communication between the first (e.g. relay) UE and the second (e.g. remote) UE may be interrupted.

In some embodiments, after receiving a paging indication from another network operator, the first (e.g. relay) UE may send a message to the second (e.g. remote) UE requesting traffic/service/quality of service (QoS) information of the second (e.g. remote) UE. Once the first (e.g. relay) UE has received this information, the first (e.g. relay) UE may decide whether or not to leave the current network and join the new network.

If the first (e.g. relay) UE decides to leave the current network and join the new network, the first (e.g. relay) UE may send a further message to the second (e.g. remote) UE informing the second (e.g. remote) UE about the decision to leave the current network. The first (e.g. relay) UE may also inform the second (e.g. remote) UE of the cause for leaving the network.

If the first (e.g. relay) UE decides to stay in the current network (and remain as a relay UE for the remote UE), the first (e.g. relay) UE may also inform the second (e.g. remote) UE of such a decision. This is because the first (e.g. relay) UE may need to modify the charging rules for the sidelink (relay) operations (e.g. how much the remote UE needs to pay and how much the relay UE earns for receiving and providing the relay service, respectively). Further, if the first (e.g. relay) UE decides to stay in the current network (and remain as relay UE for the remote UE), the first (e.g. relay) UE may inform the network from which it received the paging message about its decision to remain in the current network.

If the first (e.g. relay) UE decides to leave the current network and join the one from which it was paged, the first (e.g. relay) UE may decide to carry the second (e.g. remote) UE into the new network, for example, provided that the second (e.g. remote) UE has a subscriber identity module (SIM) card that is compatible with the new network. The first (e.g. relay) UE may communicate to the new network that it is currently connected to the second (e.g. remote) UE, and determine whether the second (e.g. remote) UE can be moved to the new network. The new network may reply with a positive or negative acknowledgment regarding moving the second (e.g. remote) UE along with the first (e.g. relay) UE, and the first (e.g. relay) UE may decide accordingly on whether to move or not.

Some embodiments described herein provide a method for how a UE in a sidelink relay scenario can handle relay communication in scenarios where one or more UEs involved in such relay communication are MUSIM capable and may need to move between different networks.

For example, some embodiments provide methods for how a UE may avoid or stop acting as a relay for UEs in one PLMN when changing to be associated with another PLMN. Some embodiments further provide methods for how two UEs (e.g. including a relay UE and a remote UE) can jointly move from a first network to a second network due to multi-SIM or MUSIM purposes (i.e. because one or both of them need to change networks).

Certain embodiments may provide one or more of the following technical advantage(s).

Some embodiments may provide for coordination of gaps for MUSIM purposes between the network and a first (e.g. relay) UE, and/or between a first (e.g. relay) UE and a second (e.g. remote) UE. Such coordination can enable the network to make better decisions on which gaps to configure for a MUSIM UE in the context of sidelink, while also improving the communication between the first (e.g. relay) UE and the second (e.g. remote) UE when the first (e.g. relay) UE is a MUSIM UE.

Some embodiments described herein enable a first (e.g. relay) UE, which is capable of MUSIM operations, to take into account not only its own traffic but also the traffic of a second UE (e.g. remote UE for which it is acting as a relay UE) in the event that the first (e.g. relay) UE is paged by another network.

Some embodiments may help to avoid the second (e.g. remote) UE experiencing a sudden, extended connection interruption when the first (e.g. relay) UE changes networks. In addition, important uses cases/services that are operated at the second (e.g. remote) UE may be taken into account by the first (e.g. relay) UE when deciding whether to leave a current network to join a new network.

Some embodiments described herein may help to provide that a UE, which is capable of acting as a relay UE, will not act as a relay for UEs in a PLMN to which the UE is not currently connected to, but instead help to ensure that the UE only acts as a relay to UEs in the network to which the UE is connected. This may help to ensure that a remote UE will not connect to a relay UE, which is currently not able to serve the remote UE due to not being in the correct PLMN.

Some embodiments may also allow a relay connection between two UEs to be maintained when one (or both) of the UEs move from one PLMN to another. This can reduce communication interruptions experienced by the UEs.

Some of the embodiments contemplated herein will now be described more fully with reference to the accompanying drawings. Embodiments are provided by way of example to convey the scope of the subject-matter to those skilled in the art.

Some embodiments are described herein in the context of the new radio (NR) radio access technology (RAT). However, the embodiments are also applicable to a long term evolution (LTE) RAT and/or any other RAT that enables direct communication between two (or more), e.g. nearby, devices.

In the description below, the term “RM UE” or “remote UE” refers to a UE that is able to transmit a packet to and/or receive a packet from a radio access network (RAN) node (e.g. gNB) via an intermediate mobile terminal (the UE to NW relay UE), which is referred to herein as an “RL UE” or “relay UE”.

The description below generally refers to the RL UE as a “first UE” and the RM UE as a “second UE”. However, the “first UE” could be either a RM UE or a RL UE, and the “second UE” could be either a RM UE or a RL UE. Hence, the solutions described herein may also be applied for a case with more than two UEs, e.g. multiple RM UEs which are connected to a RL UE. The solutions described herein may be applied for a case where two UEs cooperate to send data of one of those UEs to the network, e.g. aggregating the Uu-connections of both of those UEs.

The link or radio link over which the signals are transmitted between at least two UEs for device to device (D2D) operation is referred to herein as the sidelink (SL). The signals transmitted between the UEs for D2D operation are referred to herein as SL signals. The term SL may also interchangeably be referred to as a D2D link, vehicle-to-everything (V2X) link, proximity services (ProSe) link, peer-to-peer link, PC5 link, etc. The SL signals may also interchangeably be referred to as V2X signals, D2D signals, ProSse signals, PC5 signals, peer-to-peer signals, etc.

Further, even if the embodiments described herein are directed to sidelink relay scenarios, the embodiments may be applied also to normal sidelink operations where two UEs are involved in sidelink operation with or without the involvement of the network.

In the description below, it is assumed that the first (e.g. relay) UE is capable of dual (or multi, e.g. more than two) SIM operations and can thus, for example, be paged by two different network operators. The second (e.g. remote) UE may or may not support dual SIM operations.

In the description below, when a UE is “associated” with a first PLMN, it may mean that the UE is connected to the network of that first PLMN. However, a UE capable of Multi-SIM or MUSIM operation may be registered (e.g. at the same time) to a second PLMN. The UE may further monitor certain channels of the network of the second PLMN, for example, monitor paging.

In the examples described below, a multi-SIM or MUSIM capable UE can be associated with two PLMNs. The embodiments described herein are therefore described using examples with two PLMNs. However, the embodiments may apply to more than two SIMs and/or associated PLMNs.

Some embodiments provide systems/methods for handling of communication gaps for multi-SIM or MUSIM purposes. However, the gaps may be configured for other purposes besides multi-SIM or MUSIM purposes.

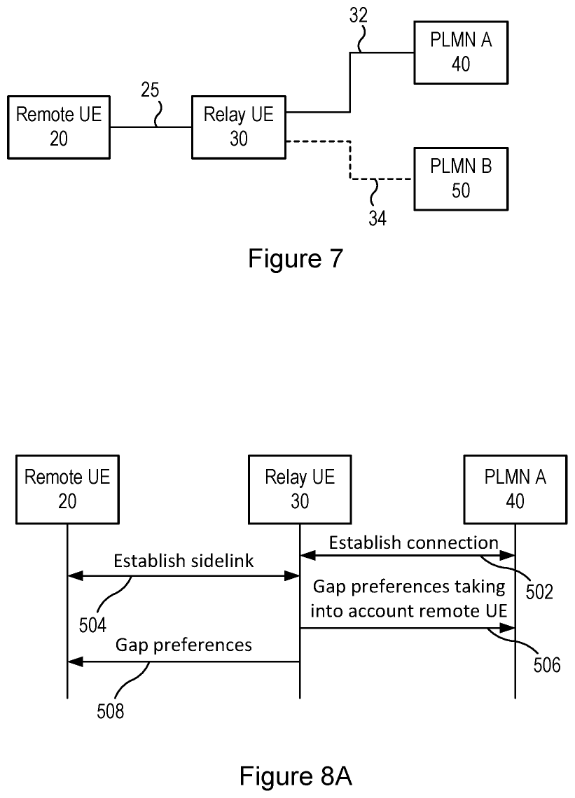

FIG. 7 illustrates a system according to an embodiment. Referring to FIG. 7, a remote UE 20 that has sidelink capabilities is connected via a (e.g. PC5) sidelink channel 25 to a peer UE 30 that also has sidelink capabilities. The peer UE 30 can be the destination of traffic from the remote UE 20 or can help the remote UE 20 connect to one or more networks, such as a first PLMN (“PLMN A”) 40 or a second PLMN (“PLMN B”) 50, in which case the peer UE 30 acts as a UE to network relay, or more simply a relay UE, for the remote UE 20. The relay UE 30 may be a MUSIM capable device that can support connections to different networks, such as PLMN A 40 and PLMN B 50. In the example shown in FIG. 7, the relay UE 30 has an active (e.g., RRC_CONNECTED) connection to PLMN A 40 as indicated by a solid line 32, and an inactive or idle (e.g., RRC_IDLE) connection to PLMN B 50 as indicated by a dashed line 34.

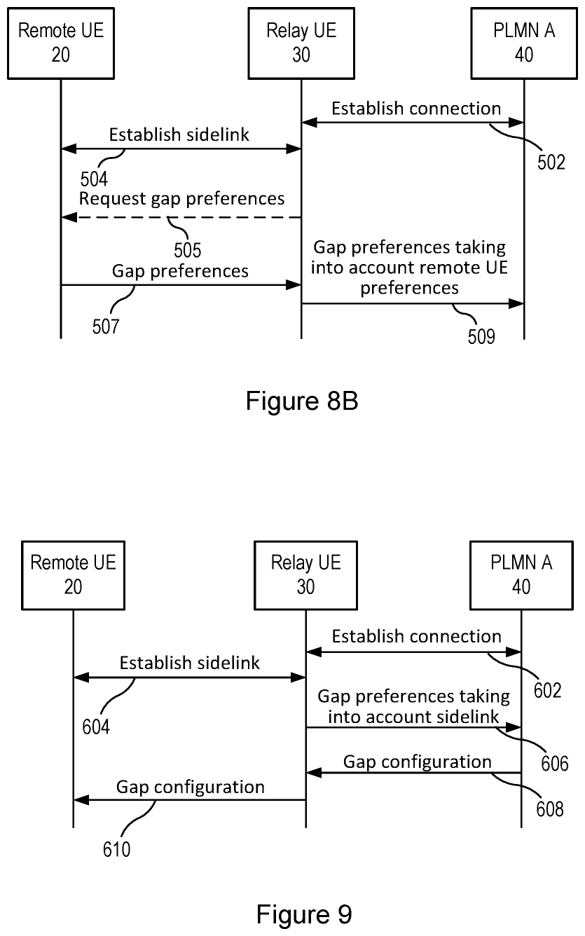

FIG. 8A is a signalling diagram illustrating an exchange of signals in a system according to an embodiment. Referring to FIG. 8A, according to some embodiments, a UE 30 that is capable of MUSIM operation establishes a connection to a network (as illustrated by arrow 502). The UE 30 then establishes a sidelink connection to a remote UE 20 for which the UE 30 acts as a relay UE to the network (as illustrated by arrow 504). The relay UE 30 informs the network (e.g., PLMN A 40) via a signalling indication (as illustrated by arrow 506) of gap preferences, which also account for gap preferences of the remote UE 20.

Compared to an indication of gap preferences corresponding only to the preferences of the remote UE 20, the indication 506 of gap preferences of both the relay UE 30 and the remote UE 20 may contain different values in any gap-related parameter. For example, the indication 506 may request a larger gap length, more frequent periodicity, smaller offset value, etc., compared to an indication of gap preferences of the remote UE 20 only.

In some embodiments, the indication 506 of gap preferences of both the relay UE 30 and the remote UE 20 may be carried as a UE assistance information message from the relay UE 30 to the PLMN A 40. Alternatively, the indication 506 may be carried in a sidelink UE information message from the relay UE 30 to the PLMN A 40 to indicate to the network that this gap preference takes into account the ongoing sidelink transmission.

The indication 506 of gap preferences of both the relay UE 30 and the remote UE 20 may indicate periodic gap preferences and/or aperiodic gap preferences.

The indication 506 of gap preferences of both the relay UE 30 and the remote UE 20 may include an offset that the network is to apply on top of the gap preference of the first UE in order to indicate the gap preference of the second UE. For instance, if a gap pattern “X” is indicated in the gap preference of the first UE, if the offset indicated is “A”, this means that the gap pattern of the gap preference of the second UE is “X+A”.

The indication 506 may also explicitly identify whether the gap preferences reported by the relay UE 30 correspond solely to the gap preferences of the relay UE 30, or to the relay UE 30 and the remote UE 20.

Still referring to FIG. 8A, in some embodiments, the relay UE 30 may send an indication (as illustrated by arrow 508) to the remote UE 20 to indicate gap preferences for MUSIM purposes.

The indication 508 may inform the remote UE 20 of periods of unavailability of the communication between the relay UE 30 and the remote UE 20.

The indication 508 may be carried, for example, in a UE assistance information message, and may indicate periodic gap preferences and/or aperiodic gap preferences.

If a previous gap preference has already been indicated by the relay UE 30, the indication 508 may include an offset that the remote UE 20 is to apply in addition to the gap preference of the relay UE 30 in order to understand the new gap preference of the relay UE 30. For instance, if a gap pattern “X” is indicated in the previous gap preference of the relay UE 30, if the offset indicated is “A”, this means that the new gap pattern of the new gap preference of the relay UE 30 is “X+A”.

The indication 508 may also be realized via network control, e.g. the network may configure the relay UE 30 to provide gap preferences to the remote UE 20.

In some embodiments, the relay UE 30 informs the remote UE 20 about the actual gaps that the relay UE 30 applies or is configured with. This is beneficial since it may be that the relay UE 30 has a preference for a certain gap configuration, but the network cannot or does not configure that particular gap configuration. In this version of this embodiment, the relay UE 30 indicates the actually configured or used gaps.

In some embodiments, the second UE may inform gap preferences to the network and/or to the first UE.

FIG. 8B is a signalling diagram illustrating an exchange of signals in a system according to an embodiment. Referring to FIG. 8B, in some embodiments, a relay UE 30 that is capable of MUSIM operation and configured to provide gap preferences for MUSIM purposes, establishes a connection to PLMN A 40 (as illustrated by arrow 502) and a sidelink connection via the PC5 interface to the remote UE 20 (as illustrated by arrow 504). The relay UE 30 sends a signaling message (as illustrated by arrow 505) to the remote UE 20 to ask for a gap preference from the remote UE 20. The remote UE 20 responds by sending an indication (as illustrated by arrow 507) of gap preferences to the relay UE 30. The relay UE 30 may then send an indication (as illustrated by arrow 509) of the combined gap preferences of the relay UE 30 and the remote UE 20 to the network (PLMN A 40).

In some embodiments, the remote UE 20 may indicate a gap preference to the relay UE 30 without having first received the request 505 from the relay UE 30.

In some embodiments, the remote UE 20 may inform the relay UE 30 of its gap preference (e.g. to also be eventually forwarded to the network) when one or more criteria is met. For example, the remote UE 20 may inform the relay UE 30 of its gap preference upon receiving an enquiry message from the relay UE 30, upon receiving an enquiry message from the network via the relay UE 30, when a sidelink connection is established between relay UE 30 and the remote UE 20 and the relay UE 30 has MUSIM capabilities, when a sidelink connection is established between the relay UE 30 and the remote UE 20 and the relay UE 30 is connected to PLMN A 40 and PLMN B 50, and/or when a sidelink connection is established between the relay UE 30 and the remote UE 20, and the relay UE 30 indicates to the remote UE 20 that is connected to PLMN A 40 and PLMN B 50.

FIG. 9 is a signalling diagram illustrating an exchange of signals in a system according to an embodiment. Referring to FIG. 9, further embodiments are illustrated. Referring to FIG. 9, according to some embodiments, a UE 30 that is capable of MUSIM operations establishes a connection to a network (as illustrated by arrow 602). The UE 30 then establishes a sidelink connection to a remote UE 20 for which the UE 30 acts as a relay UE to the network (as illustrated by arrow 604). The relay UE 30 informs the network (e.g., PLMN A 40) via a signalling indication (as illustrated by arrow 606) of gap preferences which also account for gap preferences of the remote UE 20. The network (e.g. PLMN A, 40) responds to the relay UE 30 with a gap configuration (as illustrated by arrow 608) that may or may not match the gap preferences provided by the relay UE 30. The relay UE 30 may then send an indication (as illustrated by arrow 610) to the remote UE 20 of the gap configuration provided by the network.

In some embodiments, a remote UE 20, connected to a relay UE 30 via a (e.g. PC5) connection, sends a signaling message to the relay UE 30 to indicate gap preferences for MUSIM purposes. Such gap preferences may account for possible activities the remote UE 20 may have to perform, for example, in an RRC_INACTIVE state in another network, while in an RRC CONNECTED within the network where it is connected to the relay UE 30. The gap preferences may be based on a traffic/service/QoS service the remote UE 20 has, and not necessarily represent gaps the remote UE 20 may need to perform activities as a MUSIM UE, but rather to assist the relay UE 30 (which may be MUSIM-capable) to build its preferences to be indicated to the network.

Based on the gap preferences provided by the remote UE 20, the relay UE 30 may build its own gap preferences to be reported to the network. Alternatively, the gap preference of the remote UE 20 may be indicated from the remote UE 20 directly to the network (e.g. via an encapsulated message).

In some embodiments, the network may configure the relay UE 30 to provide gap preferences that take into account a remote UE 20.

In one embodiment, the signalling between the remote UE 20, the relay UE 30 and the network (e.g. PLMN A 40), and the signalling between two network nodes in the network, can be performed according to the following cases.

For signalling between the remote UE 20, the relay UE 30 and the network (e.g. PLMN A 40), dedicated RRC signaling, which may be an existing RRC signaling or a new RRC signaling, may be used. Such RRC signaling may be in the format of a message, such as an UEAssistanceInformation or SidelinkUEInformation message.

In some embodiments, medium access control (MAC) control element (CE) based signaling, which may be an existing MAC CE or a new MAC CE for carrying the signaling, may be used.

In further embodiments, the relay UE 30 may initiate a random access channel (RACH) procedure towards the network (e.g. PLMN A 40) to carry the signaling. The signaling may include a RACH-scheduling request (SR) message.

In some embodiments, a 4-step random access (RA) procedure can be triggered to carry the signaling. For example, Msg1 of the RA procedure may be used to carry the signaling. In some embodiments, a dedicated preamble or dedicated RACH occasions may be allocated to the UE for indicating the above signaling information. The allocation may be pre-defined, determined based on a pre-defined rule, or configured by another node.

In a further example, Msg3 of the RA procedure may be extended to carry the signaling information. In Msg3, the MAC entity of the relay UE 30 may add an indicator indicating the signaling information. The indicator may be a field in the MAC subheader or carried in a MAC CE.

In some embodiments, a 2-step RA procedure can be triggered to carry the signaling. For example, a dedicated preamble or dedicated RACH occasions or dedicated PUSCH occasions/resources may be allocated to the UE for indicating the signaling information. Alternatively, indicators can be included in the MsgA payload. The indicator may be a field in the MAC subheader or carried in a MAC CE.

Alternatively, an RRC message may be included (partly or fully) in a RACH message, which includes the above signaling information from the UE.

In some embodiments, the UE may initiate a physical uplink control channel (PUCCH) transmission for indicating the signaling information. Separate dedicated PUCCH resources may be configured to the UE accordingly. The signaling could be a PUCCH-scheduling request (SR) message. The initiation of the PUCCH transmission for indicating the signaling information can be referred to herein as “Option a-4”.

In some embodiments, the UE may initiate a configured grant-based transmission for carrying the signaling. Separate dedicated configured grant resources may be configured accordingly. Alternatively, the signaling information may be included in the configured grant uplink control information (CG-UCI). The initiation of the configured grant-based transmission for carrying the signaling can be referred to herein as “Option a-5”.

Specifically, as an additional example to Option a-4 and Option a-5, the UE can transmit the signaling in the PUCCH uplink control information (PUCCH-UCI) which can be carried in the PUCCH or multiplexed with physical uplink shared channel (PUSCH).

In an example, the UE may transmit a scheduling request (SR) or buffer status report (BSR) on the direct path to the RAN node (e.g. gNB) for indicating that the UE prefers to perform transmission or reception using the direct path.

For signaling from the remote UE 20 to the network (e.g. PLMN A 40) via the relay UE 30, the remote UE 20 may use dedicated Uu RRC signaling, which may be an existing RRC signaling or a new RRC signaling. The remote UE 20 can maintain an end-to-end (E2E) connection to the network (e.g. PLMN A 40) via a L2 relay UE 30. Therefore, the remote UE 20 can send Uu RRC signaling to the network via the relay UE 30.

In an alternative, two-hop signaling may be used in which the remote UE 20 first sends the signaling to the relay UE 30 via the PC5 interface using a signaling technique, such as RRC signaling (e.g. PC5 RRC), PC5-S signaling, a discovery message, a control PDU of a protocol layer such as PDCP, RLC, or an adaptation layer, a MAC CE, and/or L1 signaling on physical channels including physical sidelink shared channel (PSSCH), physical sidelink control channel (PSCCH), physical sidelink feedback channel (PSFCH), or a new physical channel.

In some embodiments, a scheduling request (SR) may be introduced on the sidelink. An SR may be transmitted on one of the above physical channels or a new physical channel. The remote UE 20 can therefore transmit an SR to the relay UE 30 for indicating that the remote UE 20 prefers to perform transmission or reception using the indirect path.

After the relay UE 30 receives the signaling from the remote UE 20, the relay UE 30 forwards the signaling to the network (e.g. PLMN A 40) via the Uu interface using a signaling technique, such as dedicated RRC signaling, a control PDU of a protocol layer such as PDCP, RLC, or an adaptation layer, MAC CE based signaling, a RACH procedure to carry the signaling, e.g., RACH-SR signaling, a PUCCH transmission for indicating the signaling information, e.g., PUCCH-SR signaling, and/or a configured grant-based transmission for carrying the signaling.

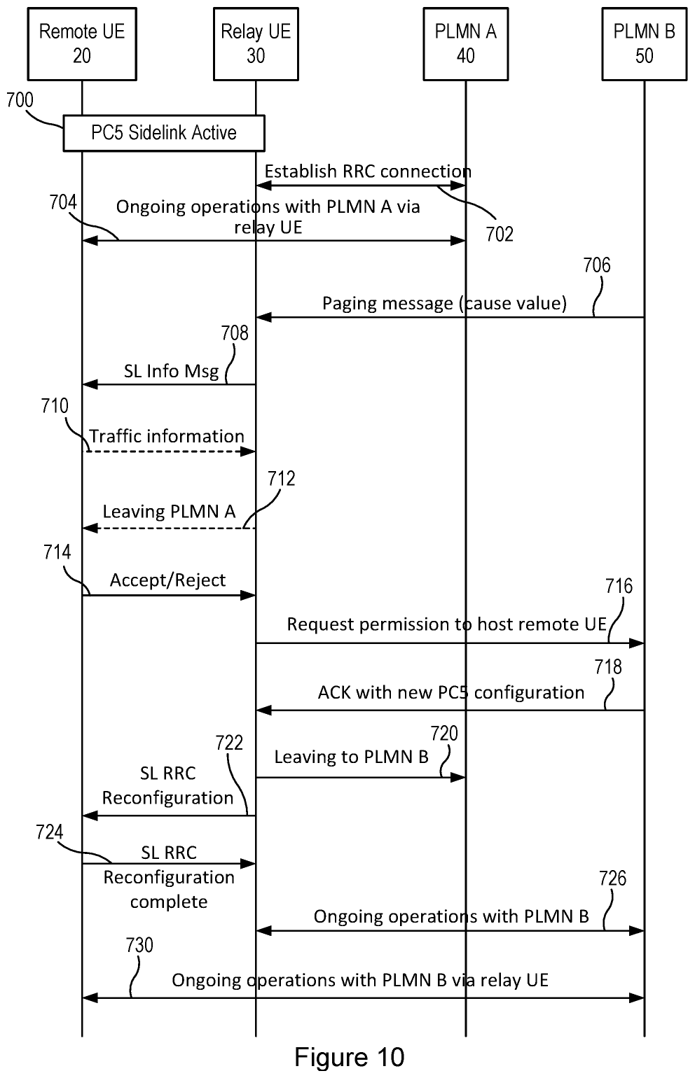

FIG. 10 is a signalling diagram illustrating an exchange of signals in a system according to an embodiment. Referring to FIG. 10, a relay UE 30, which is capable of MUSIM operation and which is currently associated with a PLMN (e.g., PLMN A 40), has an active (e.g. PC5) sidelink connection (as illustrated by block 700) to a remote UE 20. The relay UE 30 has ongoing operations (as illustrated by arrow 702) with PLMN A 40. The remote UE 20 also has ongoing operations (as illustrated by arrow 704) with PLMN A 40 via the sidelink connection to the relay UE 30.

The relay UE 30 receives a paging message (as illustrated by arrow 706) from a different PLMN (e.g., PLMN B 50). The paging message may include a cause value that indicates a reason for the paging message. Upon receipt of the paging message, the relay UE may send a sidelink information message (as illustrated by arrow 708) to the remote UE 20. The sidelink information message 708 may indicate that the relay UE 30 intends to leave the current network (PLMN A 40) and join a new network (PLMN B 50).

In some embodiments, the sidelink information message 708 may not explicitly indicate that the relay UE 30 will leave the current network, but may just indicate that the communication between the relay UE 30 and the remote UE 20 is going to be interrupted.

In some embodiments, the sidelink information message 708 may further indicate that the relay UE 30 has received a paging message from another PLMN. The message 708 may identify the PLMN that paged the relay UE 30.

When sending the message 708 to the remote UE 20, the relay UE 30 may also indicate whether or not the relay UE 30 intends to leave the current network and connect to the new network. The message 708 can also include a cause for leaving the current network.

After receiving the message 708 from the relay UE 30, the remote UE 20 may send a message (as illustrated by arrow 714) back to the relay UE 30, which indicates that the remote UE 20 accepts or rejects the relay UE 30 leaving the current network to join the new network.

In some embodiments, the relay UE can request QoS/traffic/service information from the remote UE for deciding whether to join PLMN B 50.

For example, still referring to FIG. 10, in some embodiments, the sidelink information message 708 may request that the remote UE 20 provide traffic/service/QoS information to the relay UE 30 to assist the relay UE 30 in making a decision on whether or not to leave the current network and join the new network. This may be performed because the relay UE 30 may not be aware of what type of traffic/QoS/service the remote UE 20 has, since the remote UE 20 is the source of the traffic.

In response, the remote UE 20 may transmit a message (as illustrated by arrow 710) to the relay UE 30 containing the requested traffic/service/QoS information.

Once the relay UE 30 has received the information about the traffic/service/QoS of the remote UE 20, the relay UE 30 may make a decision on whether or not to leave the current network (PLMN A 40) and join the new network (PLMN B 50). The decision of whether or not to leave the current network and join the new network can be made according to one or more criteria. For example, the relay UE 30 may take into account whether the priority of the traffic/service/QoS of the remote UE 20 is higher or lower than the priority of the traffic over the new network, whether the priority of the traffic/service/QoS of the remote UE 20 is higher or lower than a threshold, whether the priority of the traffic/service/QoS of the new network is higher or lower than a threshold, the remaining data volume on the remote UE 20, the type of traffic/service/QoS of the remote UE 20, the type of traffic/service/QoS of the new network, etc.

Further, if the relay UE 30 decides to leave the current network and join the new network, the relay UE 30 may send a message (as illustrated by arrow 712) to the remote UE 20 in order to inform the remote UE 20 that it is joining the new network. The message 712 may include a cause for leaving the current network.

In response, the remote UE 20 may send a message (as illustrated by arrow 714) to the relay UE 30 indicating whether the remote UE 20 accepts or rejects the change of network.

If the remote UE 20 rejects the change, the remote UE 20 may trigger the sidelink discovery procedure or a cell/relay (re)selection (if it was operating with sidelink relay) and release the current (e.g. PC5) connection with the relay UE 30.

In some embodiments, if the relay UE 30 decides to leave the current network and join the new network, the relay UE 30 may decide to carry the remote UE 20 into the new network (e.g. if the remote UE 20 has a SIM card compatible with the new network). In that case, the relay UE 30 may communicate to the new network that it is currently connected to the remote UE 20 and inquire whether the remote UE 20 can also be moved to the new network. The new network may reply with a positive or negative acknowledgment regarding moving also the remote UE 20, and the relay UE 30 may decide whether or not to move to the new network.

Accordingly, still referring to FIG. 10, if the remote UE 20 accepts the change to the new network in message 714, the relay UE 30 may send a request (as illustrated by arrow 716) to the new network (PLMN B 50) for permission to host the remote UE 20. If accepted, the new network 50 responds with an acknowledgement message (as illustrated by arrow 718) including a new (e.g. PC5) configuration for the remote UE 20.

If the request 716 is rejected by the new network (or if the remote UE 20 rejects the change to the new network), the remote UE 20 may release the current (e.g. PC5) connection with the relay UE 30 and trigger a sidelink discovery or relay/cell (re)selection procedure.

If the request 716 is accepted by the new network, the relay UE 30 may inform the current network 40 of its intent to leave in a message (as illustrated by arrow 720), and may send a sidelink RRC reconfiguration message (as illustrated by arrow 722) to the remote UE 20 with the new (e.g. PC5) configuration.

The remote UE 20 may apply the new configuration and respond with a sidelink RRC reconfiguration complete message (as illustrated by arrow 724). From that point on, the relay UE 30 may have ongoing operations (as illustrated by arrow 726) with PLMN B 50, and the remote UE 20 may have ongoing operations (as illustrated by arrow 730) with PLMN B 50 via the sidelink connection to the relay UE 30.

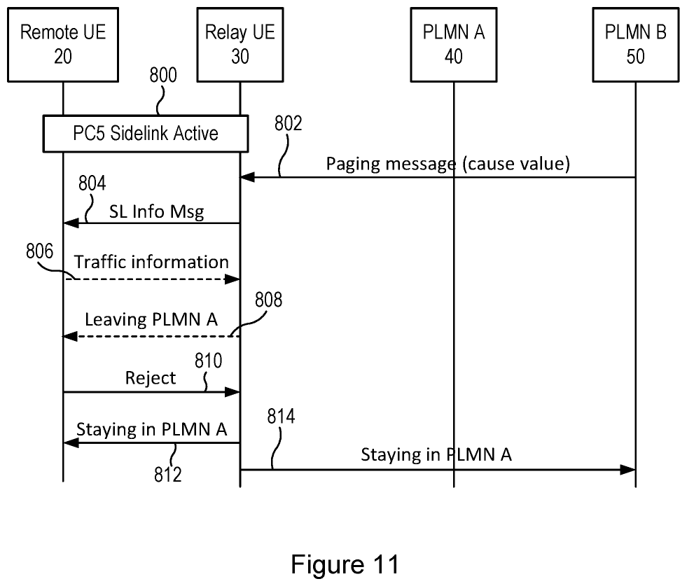

FIG. 11 is a signalling diagram illustrating an exchange of signals in a system according to an embodiment. Referring to FIG. 11, an example scenario is illustrated in which the MUSIM-capable relay UE 30, which is connected to the first network (PLMN A) 40 and which has an active (e.g. PC5) sidelink connection to the remote UE 20 (as illustrated by block 800), receives a paging message from a second network (PLMN B) 50 (as illustrated by arrow 802). The relay UE 30 sends a sidelink information message (as illustrated by arrow 804) to the remote UE 20 informing the remote UE 20 of the intention of the relay UE 30 to leave the current network. The sidelink information message 804 may request traffic/QoS/service information from the remote UE 20, which the remote UE 20 may provide in a message (as illustrated by arrow 806). The relay UE 30 may inform the remote UE 20 of its intention to leave the first network in the sidelink information message 804 or in a separate message (as illustrated by arrow 808).

In the example shown in FIG. 11, the remote UE 20 indicates in a reject message (as illustrated by arrow 810) that it rejects the change of network.

If after receiving the reject message 810 the relay UE 30 decides to stay in the current network, the relay UE 30 may send a message (as illustrated by arrow 812) to the remote UE 20 informing it of the decision not to leave the current network. This can be because this information may be considered to modify the charging rules (e.g. how much the remote UE 20 needs to pay and how much the relay UE 30 earns for using/providing the service). Also, if the relay UE 30 decides to stay in the current network, the relay UE 30 may inform the network from which it received the paging message about this in a message (as illustrated by arrow 814).

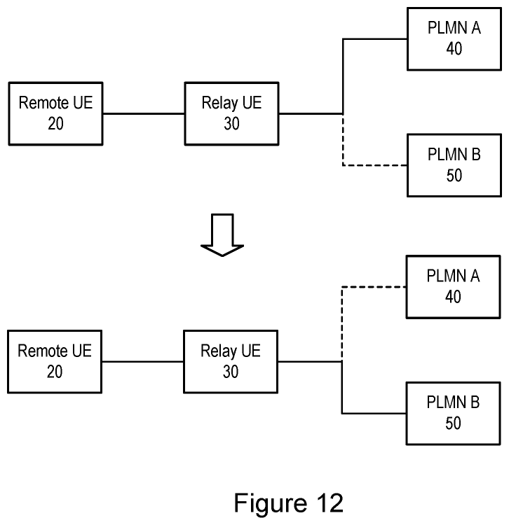

FIG. 12 illustrates a method according to an embodiment. Referring to FIG. 12, a MUSIM-capable UE 30 that is acting as a relay UE for a remote UE 20 may have an active connection to a first network, PLMN A 40 (indicated by the solid line connecting the UE 30 and the PLMN A 40) and an inactive connection to a second network, PLMN B 50 (indicated by the dashed line connecting the UE 30 and the PLMN B 50). The UE 30 may determine to move from the PLMN A 40 to the PLMN B 50 (i.e., switch to an IDLE or INACTIVE mode in the PLMN A 40 and switch to an ACTIVE mode in the PLMN B 50).

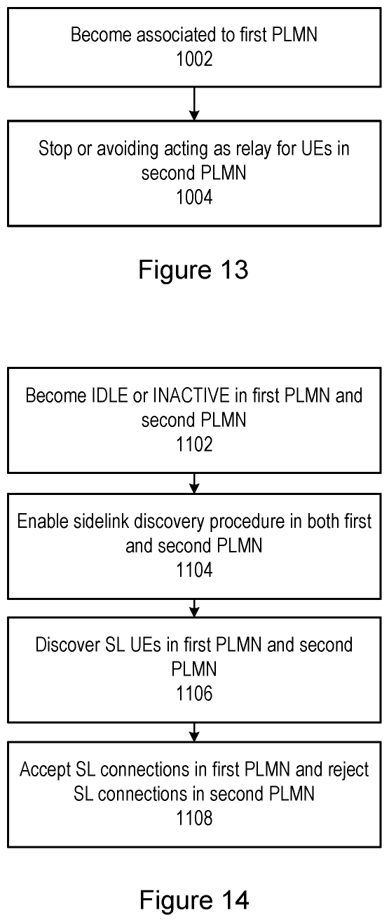

FIG. 13 illustrates a method according to an embodiment. Referring to FIG. 13, according to some embodiments, a MUSIM-capable UE that is also capable of acting as a relay for other UEs determines that it is associated with a first PLMN or a second PLMN. When the UE becomes associated with the first PLMN (block 1002), the UE avoids or stops acting as a relay for UEs of the second PLMN (block 1004). Likewise, when the UE becomes associated with the second PLMN, the UE may avoid acting as a relay for UEs of the first PLMN.

To avoid acting as a relay for UEs in a second PLMN while associated with a first PLMN, according to some embodiments, the UE may disable a sidelink discovery procedure in the second PLMN, or for UEs in the second PLMN. In some embodiments, the UE may stop an ongoing connection with UEs in the second PLMN when it becomes associated with the first PLMN.

In some embodiments, if the UE decides to perform/receive sidelink discovery, it may indicate in the discovery message the PLMN in which it is able to operate as a relay UE and/or the PLMN(s) in which it is not able to operate as a relay UE.

In some embodiments, the UE may send a busy indication in the PLMN, which may further include a time for which it will be unavailable and/or the reason for the UE to be unavailable (e.g. because it is acting as a relay for a UE in another PLMN.)

In some embodiments, the UE may broadcast a list of “non-allowed” PLMNs in which the UE is not able to operate sidelink communications or where no Uu connection is possible. As an alternative, the UE may broadcast a list of “allowed” PLMNs in which the UE is able to operate both sidelink and Uu connections.

In some embodiments, the UE may be in an IDLE/INACTIVE mode in both PLMNs.

In some embodiments, a MUSIM-capable UE that is in an IDLE or in an INACTIVE mode both in a first PLMN and a second PLMN may enable a discovery procedure for both PLMNs. If the UE starts an active connection with a UE from the first PLMN, the UE may disable a discovery procedure in the second PLMN.

FIG. 14 illustrates a method according to an embodiment. Referring to FIG. 14, a MUSIM-capable UE may become IDLE or INACTIVE in a first PLMN and a second PLMN (block 1102). The UE may enable a sidelink discovery procedure in both the first PLMN and the second PLMN (block 1104). The UE may discover UEs in the first PLMN and the second PLMN (block 1106). However, the UE may accept sidelink connections in the first PLMN and reject sidelink connections in the second PLMN (block 1108).

For example, a MUSIM-capable UE which is in IDLE or INACTIVE in both a first PLMN and a second PLMN may be discovered by or discover neighboring UEs. In case multiple UEs belonging to different PLMNs are discovered by the UE, the UE may decide to establish a sidelink communication with the UE that has a better sidelink channel (e.g., better SL-RSRP or SD-RSRP) and reject the connection(s) coming from the other UE(s). This means that all direct communication request messages received by the UEs that are not in the PLMN that has been chosen may be simply ignored or rejected. In case of rejection, the UE may send a message back to the rejected UE(s) to indicate that it does not want (or cannot) perform a sidelink transmission. The UE may further indicate a failure cause to the rejected UE(s) (e.g., because it is connected to another PLMN).

In further embodiments, a MUSIM-capable UE which is in an IDLE mode or an INACTIVE mode in both a first PLMN and a second PLMN may choose to transmit/receive sidelink discovery on only one PLMN. The UE may still allow reception or transmission of sidelink discovery messages from other PLMNs. The UE may, however, inform a discovered UE that a sidelink connection is only possible on a given PLMN. In some embodiments, the PLMN ID on which sidelink is allowed may be shared with a discovered UE.

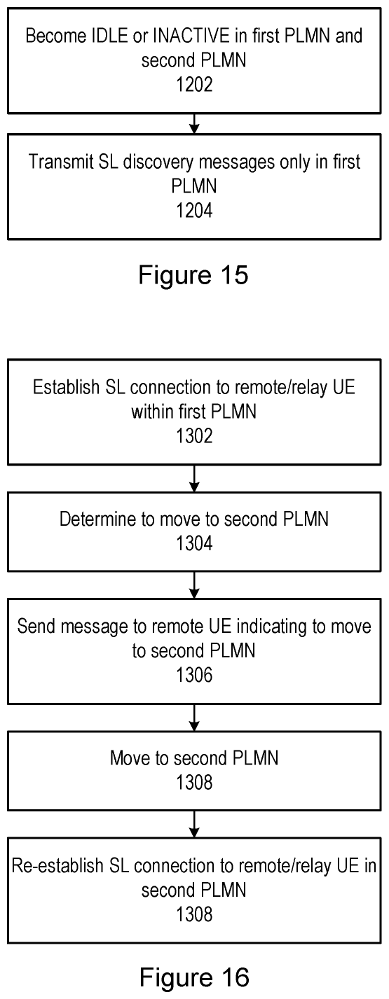

FIG. 15 illustrates a method according to an embodiment. Referring to FIG. 15, in some embodiments, a MUSIM-capable UE may become IDLE or INACTIVE in a first PLMN and a second PLMN (block 1202). The UE may thereafter transmit a sidelink discovery message only in the first PLMN (block 1204).

In further embodiments, a MUSIM-capable UE may decide to inform a discovered UE about which PLMNs can be considered as “allowed” and which PLMNs can be considered as “not-allowed”. This means that the UE informs the discovered UE that, even if the UE may be associated with multiple PLMNs, it may only be possible to establish both a sidelink connection and a Uu connection in some of them.

In some embodiments, the remote UE may join the relay UE to another PLMN.

In case a user has two related UEs, such as a smartphone and a smart watch, both UEs may have subscriptions to the same PLMNs. In some cases, the smartphone may act as a relay UE for the smartwatch, which in this example is a remote UE. It may be desirable in that case for both UEs to change networks jointly.

In some embodiments, if one UE is acting as a relay UE for another UE, and either UE needs to move from a first PLMN to a second PLMN, either UE may indicate to the other UE that it needs to switch from the first PLMN to the second PLMN.

The other UE may, in response to this, also change from the first PLMN to the second PLMN. The link between the two UEs can therefore remain (or be established again) after the change from the first PLMN to the second PLMN.

When a first UE determines to switch to the second PLMN, it may send an indication to the second UE to indicate that the first UE is switching to the second PLMN. This indication may be sent using an RRC message, MAC message, physical (PHY)-level message, etc. The second UE may, in response to this, also switch to the second PLMN.

A connection may be maintained (or established again) after the switch from the first to the second PLMN has happened.

The first UE may indicate to the second UE which PLMNs the first PLMN can be associated with, and the second UE may indicate to the first UE which PLMNs the second PLMN can be associated with.

When the first (or second) UE switches from the first PLMN to the second PLMN upon an indication from the second (or first) UE, the first (or second) UE may send an indication to its current PLMN that it is leaving the current PLMN because it is connecting to a peer UE that belongs to a different PLMN. Alternatively, if the relay UE needs to switch from the first PLMN to the second PLMN, after sending an indication to the (remote) peer UE, it may also inform the first PLMN and the second PLMN that both the relay UE and remote UE are switching PLMNs.

The UE indication may be in the format of an RRC, MAC CE, or uplink control information (UCI). In an RRC format, the UE indication can be defined as a UEAssistanceInfomation message, which can further contain a preference to leave the RRC_CONNECTED state. The UEAssistanceInformation message generated by the first (or second) UE may further contain the indication of a second (or first) UE, e.g. in the format of a container which embeds another UEAssistanceInformation message, or another field indicating that the preference to leave the RRC_CONNECTED state corresponds to a certain relay UE and other remote UEs.

FIG. 16 illustrates a method according to an embodiment. Referring to FIG. 16, in some embodiments, a MUSIM-capable UE may establish a sidelink connection to a remote or relay UE in a first PLMN (block 1302). The UE may thereafter determine that it needs to move to a second PLMN (block 1304). The UE may then send a message to the remote or relay UE indicating its intention to move to the second PLMN (block 1306), and subsequently move to the second PLMN (block 1308). The UE may then re-establish the sidelink connection with the remote or relay UE in the second PLMN (block 1308).

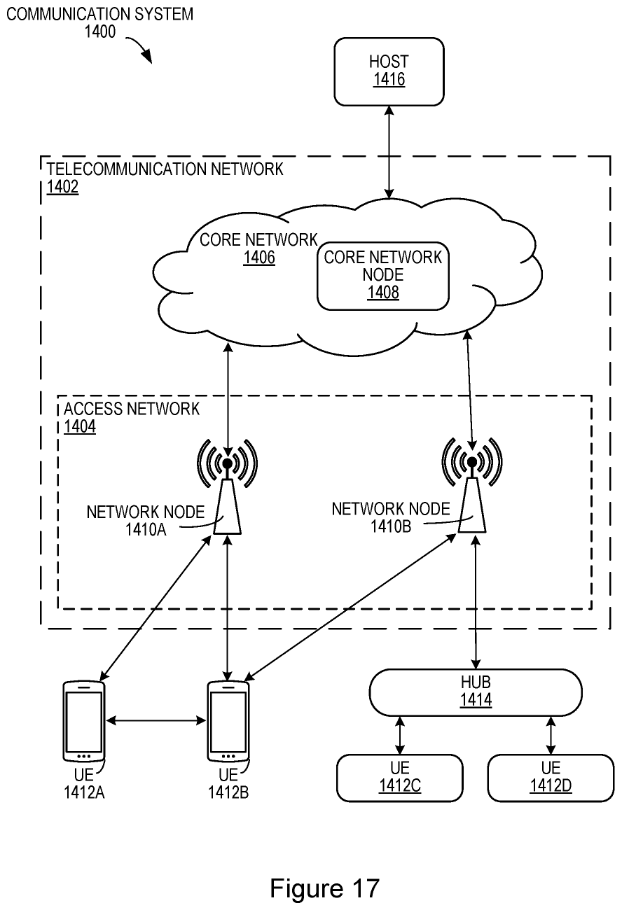

FIG. 17 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3GPP access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC), ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to a machine-to-machine (M2M) service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

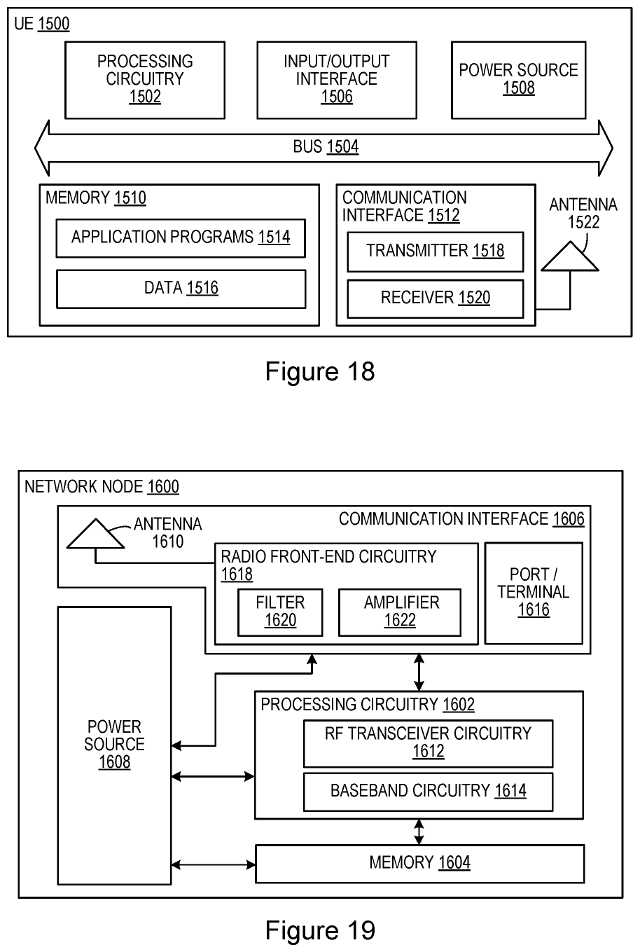

FIG. 18 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be, or be configured to include, memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 19 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

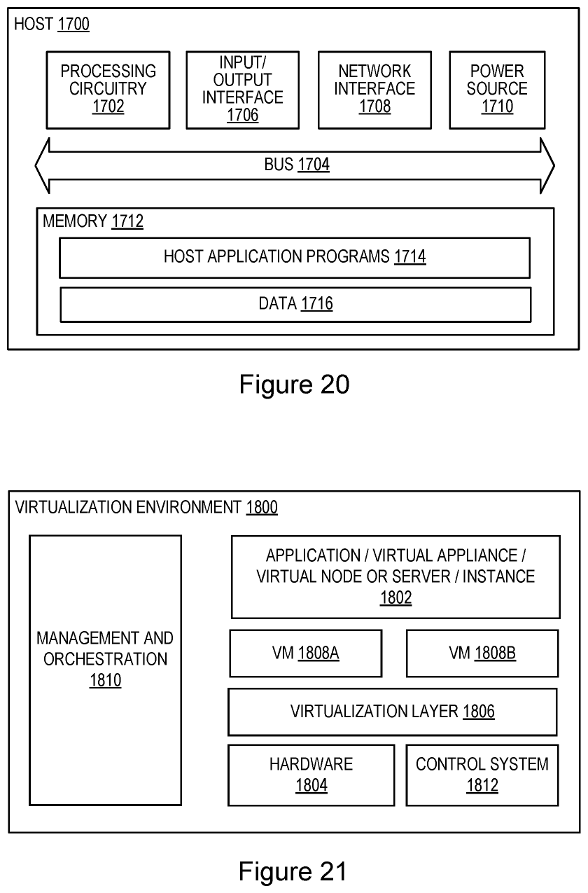

FIG. 20 is a block diagram of a host 1700, which may be an embodiment of the host 1416 of FIG. 17, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 18 and 19, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

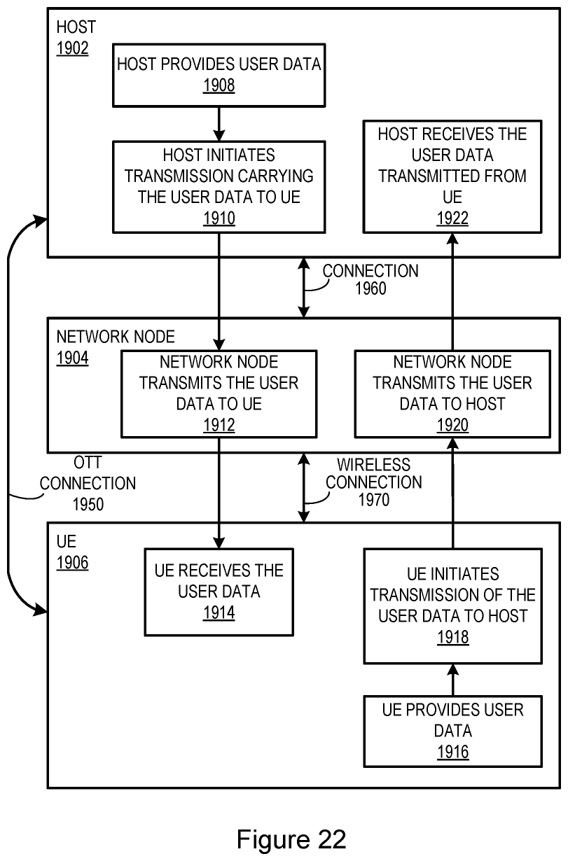

FIG. 22 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 17 and/or UE 1500 of FIG. 18), network node (such as network node 1410a of FIG. 17 and/or network node 1600 of FIG. 19), and host (such as host 1416 of FIG. 17 and/or host 1700 of FIG. 20) discussed in the preceding paragraphs will now be described with reference to FIG. 22.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 17) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve the efficiency of operation of sidelink communications involving MUSIM-capable UEs, which may provide advantages such as reduced interruptions of sidelink connections when a MUSIM-capable relay UE changes networks.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on (or in) memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Other embodiments of the present disclosure are defined in the following numbered statements:
Statement A1. A method of operating a user equipment, UE, that is capable of connecting to multiple public land mobile networks, PLMNs, using multiple universal subscriber identity modules, MUSIM, comprising:
   establishing (502) a connection to a first PLMN;
   establishing (504) a sidelink connection as a relay UE to a remote UE;
   generating a MUSIM gap preference for configuring communication gaps with the first PLMN to support MUSIM operation, wherein the MUSIM gap preferences are at least partly based on the sidelink connection to the remote UE; and
   transmitting (506) the MUSIM gap preferences to the first PLMN.
Statement A2. The method of Statement A1, wherein the MUSIM gap preferences comprise a larger gap length of more frequent periodicity than a MUSIM gap preference of the UE that is not based on the sidelink connection.
Statement A3. The method of Statement A1 or A2, wherein the MUSIM gap preference is transmitted to the first PLMN in a UE assistance information message or a sidelink UE information message.
Statement A4. The method of any of Statements A1 to A3, wherein the MUSIM gap preference comprises an offset to be applied in addition to a first gap preference of the UE that is generated without reference to the sidelink connection.
Statement A5. The method of any of Statements A1 to A4, further comprising:
   transmitting (508) the MUSIM gap preference to the remote UE.
Statement A6. The method of Statement A5, wherein the MUSIM gap preference is transmitted to the remote UE in a UE assistance information message.
Statement A7. The method of any of Statements A1 to A6, further comprising:
   requesting (505) a remote UE gap preference from the remote UE; and
   receiving (507) the remote UE gap preference from the remote UE;
   wherein the MUSIM gap preference is based on the remote UE gap preference received from the remote UE.
Statement A8. The method of any of Statements A1 to A7, further comprising:
   receiving (608) a gap configuration from the first PLMN; and
   transmitting (610) the gap configuration to the remote UE.
Statement A9. The method of any of Statements A1 to A8, wherein the MUSIM gap preference is transmitted to the first PLMN using radio resource control, RRC, signalling.
Statement A10. The method of any of Statements A1 to A9, wherein the MUSIM gap preference is transmitted to the first PLMN using medium access control, MAC signalling.
Statement A11. The method of any of Statements A1 to A10, wherein the MUSIM gap preference is transmitted to the first PLMN as part of a random access, RA, procedure.
Statement A12. A user equipment, UE, comprising:
   a processor; and
   a memory, wherein the memory comprises computer readable instructions that, when executed by the processor, cause the UE to perform operations according to any of Statements A1 to A11.
Statement A13. A computer program product comprising a non-transitory computer readable storage medium comprising computer readable instructions that, when executed by a processor of a user equipment, UE, cause the UE to perform operations according to any of Statements A1 to A11.
Statement B1. A method of operating a user equipment, UE, that is capable of connecting to multiple public land mobile networks, PLMNs, using multiple universal subscriber identity modules, MUSIM, comprising:
   establishing a connection to a first PLMN;
   establishing (700) a sidelink connection as a relay UE to a remote UE;
   receiving a paging message from a second PLMN; and
   sending a message to the remote UE indicating that the sidelink connection will be interrupted.
Statement B2. The method of Statement B1, wherein the message indicates that the UE intends to leave the first PLMN.
Statement B3. The method of Statement B1 or B2, wherein the message indicates that the UE received the paging message from the second PLMN.
Statement B4. The method of any of Statements B1 to B3, wherein the message indicates a cause for leaving the first PLMN.
Statement B5. The method of any of Statements B1 to B4, wherein the message requests traffic, quality of service and/or service information from the remote UE.
Statement B6. The method of Statement B5, further comprising receiving (710) the traffic, quality of service and/or service information from the remote UE.
Statement B7. The method of Statement B5 or B6, further comprising:
   determining whether to leave the first PLMN based on the traffic, quality of service and/or service information received from the remote UE.
Statement B8. The method of Statement B6, or Statement B7 when dependent on Statement B6, further comprising:
   after receiving the traffic, quality of service and/or service information from the remote UE. transmitting (712) an indication to the remote UE that the UE intends to leave the first PLMN.
Statement B9. The method of any of Statements B1 to B8, further comprising:
   receiving (714) an accept/reject message from the remote UE indicating whether the remote UE accepts or rejects moving to the second PLMN.
Statement B10. The method of Statement B9, wherein the accept/reject message comprises a reject message indicating that the remote UE rejects moving to the second PLMN, the method further comprising:
   in response to the reject message, determining not to leave the first PLMN; and
   transmitting a response message (812) to the remote UE indicating that the UE will stay in the first PLMN.
Statement B11. The method of Statement B9, wherein the accept/reject message comprises an accept message indicating that the remote UE accepts moving to the second PLMN, the method further comprising:
   in response to the accept message, transmitting a request (716) to the second PLMN requesting permission to host the remote UE in the second PLMN.
Statement B12. The method of Statement B11, further comprising:
   receiving (718) an acknowledgement from the second PLMN granting permission to host the remote U E in the second PLMN, wherein the acknowledgement includes a sidelink configuration for hosting the remote UE in the second PLMN; and
   transmitting the sidelink configuration to the remote UE.
Statement B13. A user equipment, UE, comprising:
   a processor; and
   a memory, wherein the memory comprises computer readable instructions that, when executed by the processor, cause the UE to perform operations according to any of Statements B1 to B12.
Statement B14. A computer program product comprising a non-transitory computer readable storage medium comprising computer readable instructions that, when executed by a processor of a user equipment, UE, cause the UE to perform operations according to any of Statements B1 to B12.
Statement C1. A method of operating a user equipment, UE, that is capable of connecting to multiple public land mobile networks, PLMNs, using multiple universal subscriber identity modules, MUSIM, comprising:
   establishing (1002) a connection to a first PLMN; and
   after establishing the connection to the first PLMN, ceasing or avoiding (1004) to act as a relay UE for UEs in a second PLMN.
Statement C2. The method of Statement C1, wherein ceasing to act as a relay UE for UEs in the second PLMN comprises disabling a sidelink discovery procedure in the second PLMN.
Statement C3. The method of Statement C1, wherein ceasing or avoiding to act as a relay UE for UEs in the second PLMN comprises stopping an ongoing sidelink connection with a UE in the second PLMN.
Statement C4. The method of Statement C1, wherein ceasing or avoiding to act as a relay UE for UEs in the second PLMN comprises indicating in a sidelink discovery message that the UE is not willing to operate as a relay UE for UEs in the second PLMN.
Statement C5. The method of any of Statements C1 to C4, further comprising indicating the sidelink discovery message a time period in which the UE is not willing to operate as a relay UE for UEs in the second PLMN.
Statement C6. The method of any of Statements C1 to C5, wherein the connection to the first PLMN comprises an inactive or idle connection, the method further comprising:
   establishing (1102) an inactive or idle connection to a second PLMN simultaneously with the inactive or idle connection to the first PLMN;
   enabling a sidelink discovery procedure in the first PLMN and the second PLMN;
   accepting a first sidelink connection from a first remote UE in the first PLMN; and
   rejecting a second sidelink connection from a second remote UE in the second PLMN.
Statement C7. The method of Statement C6, further comprising:
   determining whether to accept sidelink connections in the first PLMN or the second PLMN based on a quality of a sidelink channel of a first remote UE in the first PLMN compared to a quality of a sidelink channel of a second remote UE in the second PLMN.
Statement C8. The method of any of Statements C1 to C7, wherein the connection to the first PLMN comprises an inactive or idle connection, the method further comprising:
   establishing (1202) an inactive or idle connection to a second PLMN simultaneously with the inactive or idle connection to the first PLMN; and
   transmitting (1204) sidelink discovery messages only in the first PLMN.
Statement C9. A user equipment, UE, comprising:
   a processor; and
   a memory, wherein the memory comprises computer readable instructions that, when executed by the processor, cause the UE to perform operations according to any of Statements C1 to C8.
Statement C10. A computer program product comprising a non-transitory computer readable storage medium comprising computer readable instructions that, when executed by a processor of a user equipment, UE, cause the UE to perform operations according to any of Statements C1 to C8.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-26. (canceled)

27. A method of operating a relay user equipment, UE, that is capable of connecting to multiple public land mobile networks, PLMNs, using multiple universal subscriber identity modules, MUSIMs, the method comprising:
establishing a connection to a first PLMN;
establishing a sidelink connection to a remote UE;
generating a gap preference for configuring communication gaps with the first PLMN, wherein the gap preference is a MUSIM gap preference and the gap preference is at least partly based on the sidelink connection to the remote UE; and
transmitting the gap preference to the first PLMN.

28. The method of claim 27, wherein:
the gap preference comprises a larger gap length of more frequent periodicity than a gap preference of the relay UE that is not based on the sidelink connection;
the gap preference is transmitted to the first PLMN in a UE assistance information message or a sidelink UE information message; and/or
the gap preference comprises an offset to be applied in addition to a first gap preference of the relay UE that is generated without reference to the sidelink connection.

29. The method of claim 27, further comprising:
transmitting the gap preference to the remote UE.

30. The method of claim 27, further comprising:
requesting a remote UE gap preference from the remote UE; and
receiving the remote UE gap preference from the remote UE;
wherein the gap preference is based on the remote UE gap preference received from the remote UE.

31. The method of claim 27, further comprising:
receiving a gap configuration from the first PLMN; and
transmitting the gap configuration to the remote UE.

32. The method of claim 27, wherein:
the gap preference is transmitted to the first PLMN using radio resource control, RRC, signalling;
the gap preference is transmitted to the first PLMN using medium access control, MAC signalling; or
the gap preference is transmitted to the first PLMN as part of a random access, RA, procedure.

33. A method of operating a relay user equipment, UE, that is capable of connecting to multiple public land mobile networks, PLMNs, using multiple universal subscriber identity modules, MUSIMs, the method comprising:
establishing a connection to a first PLMN;
establishing a sidelink connection to a remote UE;
receiving a paging message from a second PLMN; and
after receiving the paging message, sending a message to the remote UE indicating that the sidelink connection will be interrupted.

34. The method of claim 33, wherein:
the message indicates that the relay UE intends to leave the first PLMN;
the message indicates that the relay UE received the paging message from the second PLMN;
the message indicates a cause for leaving the first PLMN; and/or
the message requests traffic, quality of service and/or service information from the remote UE.

35. The method of claim 33, further comprising:
receiving the traffic, quality of service and/or service information from the remote UE.

36. The method of claim 33, further comprising:
determining whether to leave the first PLMN based on the traffic, quality of service and/or service information received from the remote UE.

37. The method of claim 33, further comprising:
after receiving the traffic, quality of service and/or service information from the remote UE, transmitting an indication to the remote UE that the relay UE intends to leave the first PLMN.

38. The method of claim 33, further comprising:
receiving an accept/reject message from the remote UE indicating whether the remote UE accepts or rejects moving to the second PLMN.

39. The method of claim 33, wherein:
the accept/reject message comprises a reject message indicating that the remote UE rejects moving to the second PLMN and the method further comprises:
in response to the reject message, determining not to leave the first PLMN; and
transmitting a response message to the remote UE indicating that the relay UE will stay in the first PLMN; or
the accept/reject message comprises an accept message indicating that the remote UE accepts moving to the second PLMN and the method further comprises:
in response to the accept message, transmitting a request to the second PLMN requesting permission to host the remote UE in the second PLMN.

40. The method of claim 33, further comprising:
receiving an acknowledgement from the second PLMN granting the permission to host the remote UE in the second PLMN, wherein the acknowledgement includes a sidelink configuration for hosting the remote UE in the second PLMN; and
transmitting the sidelink configuration to the remote UE.

41. A method of operating a relay user equipment, UE, that is capable of connecting to multiple public land mobile networks, PLMNs, using multiple universal subscriber identity modules, MUSIMs, the method comprising:
establishing a connection to a first PLMN; and
after establishing the connection to the first PLMN, ceasing to establish a sidelink connection for remote UEs in a second PLMN.

42. The method of claim 41, wherein:
ceasing to establish a sidelink connection for remote UEs in the second PLMN comprises disabling a sidelink discovery procedure in the second PLMN;
ceasing to establish a sidelink connection for remote UEs in the second PLMN comprises stopping an ongoing sidelink connection with a remote UE in the second PLMN; or
ceasing to establish a sidelink connection for remote UEs in the second PLMN comprises indicating in a sidelink discovery message that the relay UE is not willing to establish a sidelink connection for remote UEs in the second PLMN.

43. The method of claim 41, further comprising:
indicating, in the sidelink discovery message, a time period in which the relay UE is not willing to establish a sidelink connection for remote UEs in the second PLMN.

44. The method of claim 41, wherein:
the connection to the first PLMN comprises an inactive or idle connection and a connection to the second PLMN comprises an inactive or idle connection, the method further comprising:
enabling a sidelink discovery procedure in the first PLMN and the second PLMN;
accepting a first sidelink connection from a first remote UE in the first PLMN; and
rejecting a second sidelink connection from a second remote UE in the second PLMN.

46. The method of claim 41, wherein:
the connection to the first PLMN comprises an inactive or idle connection and a connection to the second PLMN comprises an inactive or idle connection, the method further comprising:
transmitting sidelink discovery messages only in the first PLMN.

47. A relay user equipment, UE, comprising:
a processor; and
a memory, wherein the memory comprises computer-readable instructions that, when executed by the processor, cause the relay UE to perform the method according to claim 27.
